(19) United States
(12) Patent Application Publication
(10) Pub. No.: US 2024/0240861 A1
(43) Pub. Date: Jul. 18, 2024

(54) FOOD DEHYDRATOR

(71) Applicant: Greenfield World Trade, Inc., Fort Lauderdale, FL (US)

(72) Inventors: Rong Liu, Newark, DE (US); Thomas P. McLaughlin, Parkland, FL (US); Guohai Wu, Xintan, Shunde City (CN)

(21) Appl. No.: 18/452,903

(22) Filed: Aug. 21, 2023

Related U.S. Application Data
(60) Provisional application No. 63/479,805, filed on Jan. 13, 2023.

(51) Int. Cl. F26B 9/00; A23L 3/40; F26B 25/12; F26B 25/18

(52) U.S. Cl. CPC F26B 9/003; A23L 3/40; F26B 25/12; F26B 25/18

(57) ABSTRACT

A food dehydrator includes a housing defining a drying chamber therein with an upper wall of the housing delimiting the drying chamber in a vertical upward direction, a door moveably coupled to the housing and configured to selectively cover a front opening of the housing providing access to the drying chamber, and an upper window provided in the upper wall of the housing at a position above the drying chamber. The upper window is formed of a transparent or semi-transparent material providing visual access to the drying chamber within the housing. A recessed area is formed in the upper wall of the housing and is configured to removably receive a shelf or tray therein, and the shelf or tray is further configured for removable reception within the drying chamber of the housing and is configured to support a food item thereon during a dehydrating process.

### CROSS-REFERENCE TO RELATED APPLICATION

This patent application claims priority to U.S. Provisional Patent Application Ser. No. 63/479,805, filed on Jan. 13, 2023, the entire disclosure of which is hereby incorporated herein by reference.

### FIELD OF THE INVENTION

The disclosure relates to a dehydrator, and more particularly, to a food dehydrator with enhanced features including a stow-away door, a sky-light upper window, and a shelf or tray-receiving recessed area.

### BACKGROUND

Dehydration of products is well known and various methods of dehydrating food have been practiced for hundreds of years. Generally, the process of dehydrating food involves the removal of water from food so-as-to inhibit the growth of microorganisms and bacteria. Early dehydration was performed through exposure to sunlight and wind. In this manner, the process of food dehydration provided a method for people to preserve food for extended periods prior to consumption before the use of refrigeration or chemical preservative agents became common and well known.

Dehydration has since been conducted using dehydration equipment intended to enhance the process of dehydration. Generally, conventional dehydrators remove water from food by recirculating heated air above and below food placed on trays in a drying chamber. Depending upon the amount of food and type of food placed in the drying chamber, consumer-style food dehydrators can accomplish the water removal in timeframes of between 1-12 hours.

Accordingly, it would be advantageous to improve upon the existing dehydrators through the incorporation of features that simplify, yet improve, an operation thereof.

### SUMMARY

In concordance and agreement with the presently described subject matter, a food dehydrator with enhanced features for improved operation, has surprisingly been discovered.

According to an embodiment of the present invention, a food dehydrator includes a housing defining a drying chamber therein with an upper wall of the housing delimiting the drying chamber in a vertical upward direction, a door moveably coupled to the housing and configured to selectively cover a front opening of the housing providing access to the drying chamber, and an upper window provided in the upper wall of the housing at a position above the drying chamber. The upper window is formed of a transparent or semi-transparent material providing visual access to the drying chamber within the housing.

According to another embodiment of the present invention, a food dehydrator includes a housing defining a drying chamber therein with an upper wall of the housing delimiting the drying chamber in a vertical upward direction. A door is moveably coupled to the housing and is configured to selectively cover a front opening of the housing providing access to the drying chamber. A recessed area is formed within an outer surface of the upper wall of the housing. The recessed area is configured to removably receive a shelf or tray therein. The shelf or tray is further configured for removable reception within the drying chamber of the housing and is configured to support a food item thereon.

According to yet another embodiment of the invention, a food dehydrator includes a housing defining a drying chamber therein. A door is moveably coupled to the housing and is configured to selectively cover a front opening of the housing providing access to the drying chamber. The door is selectively positionable between a fully closed position where the door covers the front opening, a fully open position where the door is rotated away from the fully closed position to align the door axially with a stowing space provided within the housing, and a stowed position where the door is disposed at least partially within the stowing space following axial movement of the door towards the stowing space.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

The drawings described herein are for illustrative purposes only of selected embodiments and not all possible implementations, and are not intended to limit the scope of the present disclosure.

FIG. 1 is a front perspective view of a food dehydrator according to an embodiment of the presently disclosed subject matter, wherein a door of the food dehydrator is in a fully closed position;

FIG. 2 is an elevational cross-sectional view taken from the perspective of section lines 2-2 in FIG. 1;

FIG. 3 is right-side cross-sectional perspective view of the food dehydrator of FIG. 1, wherein the illustrated cross-section is taken through a central plane of the food dehydrator;

FIG. 4 is an exploded front perspective view showing two different forms of food shelves or trays configured for reception within a recessed area of an upper wall of the food dehydrator;

FIG. 5 is a front perspective view of the food dehydrator of FIG. 1 following rotation of the door to a fully open and non-stowed position;

FIG. 6 is a front perspective view of the food dehydrator of FIG. 5 following axial translation of the door into a stowing space of the food dehydrator, wherein the disclosed configuration corresponds to the door being adjusted to a fully stowed position;

FIG. 7 is a fragmentary enlarged view of a slider mechanism and stopper assembly of the food dehydrator configured to prevent incidental switching of the door between the fully open and non-stowed position and a stowed position wherein the door extends at least partially into the stowing space; and

FIG. 8 is an elevational fragmentary cross-sectional view showing the slider mechanism and the stopper assembly as taken from the perspective of section line 8 in FIG. 1.

### DETAILED DESCRIPTION

The following description of technology is merely exemplary in nature of the subject matter, manufacture and use of one or more present disclosures, and is not intended to limit the scope, application, or uses of any specific present disclosure claimed in this application or in such other applications as may be filed claiming priority to this application, or patents issuing therefrom. Regarding methods disclosed, the order of the steps presented is exemplary in nature, and thus, the order of the steps may be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. The device may be otherwise oriented (rotated 90 degrees or at other orientations) and the spatially relative descriptors used herein interpreted accordingly.

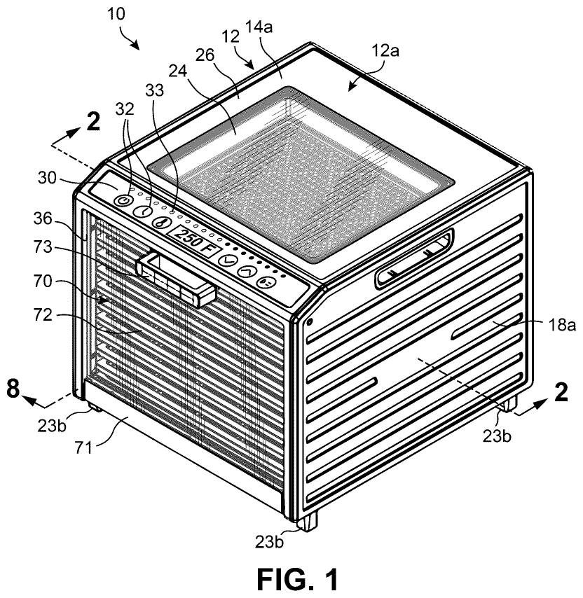

FIGS. 1-8 show an embodiment of a food dehydrator 10 in accordance with the present disclosure. The food dehydrator 10 comprises a housing 12 including an outer shell 12a and an inner shell 12b. The outer shell 12a forms an outwardly exposed surface of the food dehydrator 10 and the inner shell 12b at least partially defines a drying chamber 13 of the food dehydrator 10. The outer shell 12a may include a top wall 14a, a first lateral wall 16a, a second lateral wall 18a formed opposite the first lateral wall 16a, a bottom wall 20a, and a rear wall 22a. In the illustrated embodiment, the bottom wall 20a extends across only a portion of the bottom of the food dehydrator 10 with at least a portion of the bottom wall 20a being removed and substantially open directly below the length of the drying chamber 13. The outer shell 12a and the inner shell 12b may be supported by a support structure 23 configured to rest on a horizontal surface during use of the food dehydrator 10. The support structure 23 may include a support frame 23a extending around a perimeter of a bottom portion of the drying chamber 13 and a plurality of legs 23b depending downwardly from the support frame 23a and/or the bottom wall 20a.

The inner shell 12b of the present embodiment includes a substantially U-shaped configuration including a top wall 14b, a first lateral wall 16b, and a second lateral wall 18b formed opposite the first lateral wall 16b. The inner shell 12b is indented inwardly relative to the outer shell 12a in the vertical and lateral directions such that the top wall 14a of the outer shell 12a is spaced vertically outwardly of the top wall 14b of the inner shell 12b while each of the lateral side walls 16a, 18a of the outer shell 12a is spaced laterally outwardly of each of the corresponding lateral side walls 16b, 18b of the inner shell 12b. The indenting of the inner shell 12b relative to the outer shell 12a may form an air gap between the outer shell 12a and the inner shell 12b about an outer periphery of the inner shell 12b as viewed from the perspective of an axial direction of the food dehydrator 10 arranged perpendicular to each of the lateral and vertical directions, which corresponds to a front-to-rear direction of the dehydrator 10. Each of the inner shell 12a and/or the outer shell 12b may be produced from at least one heat-resistant material such as a sheet metal, for example. However, the food dehydrator 10 is not limited to the disclosed configuration of the outer shell 12a relative to the inner shell 12b, and alternative configurations of the housing 12 may be utilized in defining the drying chamber 13 without necessarily departing from the scope of the present invention, including the use of only one of the shells 12a, 12b in defining the drying chamber 13, so long as the resulting housing 12 maintains the remaining relationships described herein regarding the novel features of the food dehydrator 10 as described hereinafter.

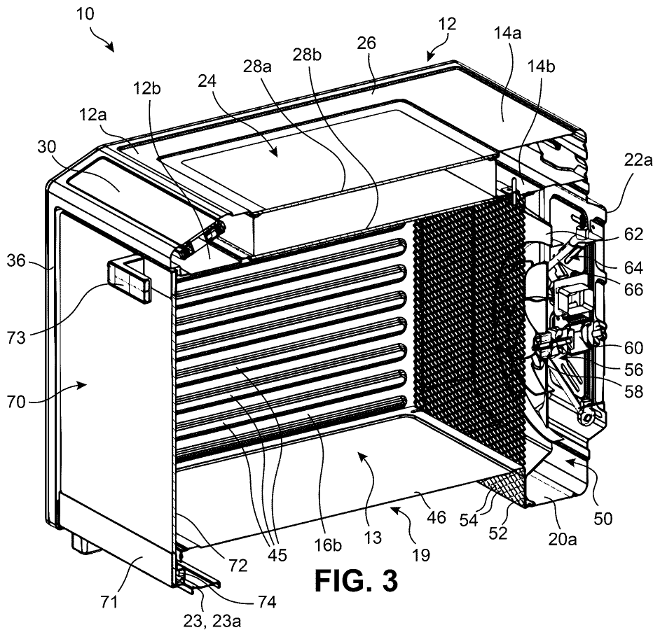

The housing 12 of the food dehydrator 10 includes an upper window 24 formed therein for providing visual access to the drying chamber 13 disposed within an interior of the food dehydrator 10. In the embodiment including each of the outer shell 12a and the inner shell 12b, as illustrated, the upper window 24 may include the use of each of a first pane 28a disposed within the outer shell 12a and a second pane 28b disposed within the inner shell 12b, wherein the panes 28a, 28b are disposed in vertical alignment with one another to allow for visual access to the drying chamber 13 through each of the outer shell 12a and the inner shell 12b. The vertical spacing of the top walls 14a, 14b also leads to the first and second panes 28a, 28b being spaced apart from one another with respect to the vertical direction, thereby forming an air gap therebetween. The upper window 24 and each of the corresponding panes 28a, 28b may include a rectangular perimeter shape, although alternative configurations may be utilized without departing from the scope of the present invention. In other embodiments where the upper wall of the housing 12 is formed by only a single structure corresponding to one of the outer shell 12a or the inner shell 12b, the upper window 24 may include a single pane disposed therethrough in the absence of a second pane and a corresponding air gap. The upper window 24 is generally configured to allow light to pass into the drying chamber 13 and/or permit the user to check a dehydration status of any food items disposed within the drying chamber 13 without interrupting an operation of the food dehydrator 10 (i.e., without opening a door of the food dehydrator 10 and pulling out shelves of the food dehydrator 10, as explained in detail hereinafter). Each of the panes 28a, 28b forming the upper window 24 may be produced from a transparent or semi-transparent material. The upper window 24 is illustrated as semi-transparent in FIG. 1 to more easily identify and differentiate the exposed surface of the outer disposed pane 28a from the remainder of the exposed housing 12, but a fully transparent material may be preferable for forming the upper window 24 to more easily distinguish the contents of the drying chamber 13 during use of the upper window 24. It should also be noted that the panes 28a, 28b of the upper window 24 are shown as opaque in FIG. 3 to more easily identify the structure thereof in the absence of the features disposed rearwardly therefrom, but the panes 28a, 28b are understood to be the transparent or semi-transparent material to provide the access of light and ability to visualize the interior contents of the drying chamber 13 in the manner described.

The upper wall of the outermost shell of the housing 12, which is the upper wall 14a of the outer shell 12a of the embodiment of the food dehydrator 10 shown in FIGS. 1-8, includes a recessed area 26 formed therein. Optionally, the recessed area 26 may be configured as a food preparation area configured to removably receive a shelf or tray 38 of the food dehydrator 10 therein in a substantially nested configuration for aiding in an affixing of a position of the shelf or tray 38 relative to the upper wall of the housing 12. Specifically, the recessed area 26 may include a perimeter shape that substantially corresponds to that in shape and size to each of the shelves or trays 38 configured for use with the food dehydrator 10 to receive at least a lower-disposed or bottom portion of each of the applicable shelves or trays 38 at least partially within the recessed area 26, which may include the bottom portion of the corresponding shelf or tray 38 having a shape that is substantially complimentary to that of the void formed by the recessed area 26. The recessed area 26 may be enlarged and spaced outwardly a slight degree relative to an exterior peripheral surface of the corresponding shelf or tray 38 to allow for some play when disposed therein, such as when facilitating a removal of the shelf or tray 38 from the recessed area 26. The recessed area 26 includes a rectangular perimeter shape that may be indented inwardly from each of the opposing lateral sides edges and opposing front and rear edges of the upper wall of the housing 12.

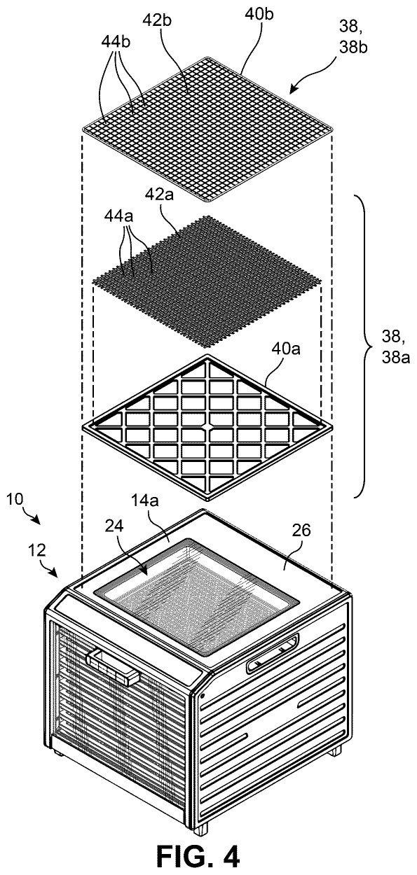

As shown in FIG. 4, various different configurations of the shelves of trays 38 may be utilized in forming a support element for supporting a food item within the drying chamber 13 of the housing 12. A first one of the compatible shelves or trays 38, identified as shelf or tray 38a in FIG. 4, may include a frame 40a configured to retain a supporting structure 42a having a plurality of openings 44a for air circulation (e.g., a perforated or mesh sheet or screen) formed therethrough. A second one of the compatible shelves or trays 38, identified as shelf or tray 38b in FIG. 4, may include a frame 40b having a supporting structure 42b coupled thereto about a perimeter of the frame 40b to form an integrated shelf or tray 38b, wherein the supporting structure 42b similarly defines a perforated or mesh sheet or screen having a plurality of openings 44b for air circulation. In other embodiments (not shown), the shelf or tray 38 may be a generally solid sheet used for drying foods that have a slurry and/or liquid consistency, or may otherwise include structure for preventing an undesired flow and/or dropping of the corresponding food item from the respective shelf or tray 38. As shown in FIG. 4, the supporting structure 42a of the shelf or tray 38a includes a size and shape for reception within a corresponding recessed area of the frame 40a, while each of the frames 40a, 40b of each of the disclosed shelves or trays 38a, 38b includes the described size and shape for vertical reception of a corresponding one of the shelves or trays 38a, 38b within the recessed area 26 of the housing 12, thereby limiting motion of the corresponding one of the shelves or trays 38a, 38b in the lateral, vertical, and axial (front-to-back) directions of the food dehydrator 10 during a process of placing the desired food items on the supporting structure 42a, 42b of the corresponding one of the shelves or trays 38a, 38b.

As shown in FIG. 1, the upper window 24 may be formed in the recessed area 26 of the housing 12 to provide the visual access to the drying chamber 13. Specifically, the upper window 24 may be formed in a front-ward section of the recessed area 26 disposed directly above a portion of the drying chamber 13 configured to receive the shelves or trays 38 therein during a dehydrating process. The upper window 24 is indented inwardly from a perimeter of the recessed area 26 in the illustrated embodiment, but the upper window 24 may be formed through any portion of the recessed area 26 while remaining within the scope of the present invention. Additionally, the upper window 24 is not limited to being formed within the recessed area 26, and may be formed through the housing 12 at the specified position regardless of the presence of the recessed area 26 therein while remaining within the scope of the present invention.

A control panel 30 may be coupled to the housing 12 at a position for access by a user during the initiation and monitoring of a dehydrating process carried out via the food dehydrator 10. In certain embodiments, the control panel 30 may be located on the top wall 14a of the food dehydrator 10, such as being disposed along a front edge or area of the top wall 14a. However, it is understood that the control panel 30 may be located elsewhere on the food dehydrator 10 that is convenient and easy to access by the user. The control panel 30 may include one or more control elements 32 (e.g., push buttons, knobs, switches, sliders, and the like) that are configured to control particular features of the food dehydrator 10. For example, FIG. 1 depicts the control panel 30 as including control elements 32 corresponding to a selection of an ON/OFF setting, a timer setting, a temperature setting, an upward or increasing selection setting, a downward or decreasing selection setting, a PLAY/PAUSE setting, and/or the like, may be provided on the control panel 30. In certain embodiments, the control panel 30 may further include a progress indicator 33 to provide the dehydration status to the user. The progress indicator 33 may permit the user to check the dehydration status instantly, even at a relatively far distance from the food dehydrator 10. In the illustrated example, the progress indicator 33 includes a plurality (20) of spaced apart and linearly arranged graphical indicia that are configured to toggle between an active appearance/state (lit-up, shown as white in FIG. 1) and an inactive appearance (not lit-up, shown as black in FIG. 1), wherein the number of active to inactive indicia is representative of a percentage of dehydration remaining and/or a percentage of dehydration completed. In the example of FIG. 1 twelve of the graphical indicia are shown as being active and corresponding to the amount of dehydration remaining while eight of the graphical indicia are shown as being inactive and corresponding to the amount of dehydration already completed, hence the example of FIG. 1 corresponds to about 40% of the dehydration process being complete with about 60% of the dehydration process remaining to be completed. It should be readily apparent that alternative methods of showing the progress may be utilized, including a different manner of interpreting the active/inactive states of the indicia and/or utilizing a different graphical representation of the progress that has occurred, such as utilizing a pie chart or a written percentage to represent the completed vs the remaining dehydration that must occur.

A front opening 36 of the housing 12 may provide access into the drying chamber 13, which is configured to receive one or more of the shelves or trays 38 extending across the drying chamber 13, as depicted in FIGS. 1, 2, and 4-6. Each of the shelves or tray 38 may be held in place within the drying chamber 13 via support on a pair of opposing horizontal projections 45 formed in the lateral side walls 16b, 18b of the inner shell 12b. Specifically, the horizontal projections 45 are formed by upper disposed and horizontally arranged surfaces of inwardly projecting corrugations of each of the opposing lateral side walls 16b, 18b, wherein the corrugations extend longitudinally in the axial direction while being spaced apart from one another with respect to the vertical direction. Numerous opposing pairs of the horizontal projections 45, spaced apart from one another vertically, may be provided for in the inner shell 12b to permit the shelves or trays 38 to be vertically adjusted to a desired vertical position within the drying chamber 13. Preferably, the pairs of the projections 45 are arranged to support the shelves or trays 38 in a parallel and equally vertically spaced-apart relationship, although alternative configurations of the shelves or trays 38 within the drying chamber 13 may be utilized while remaining within the scope of the present invention.

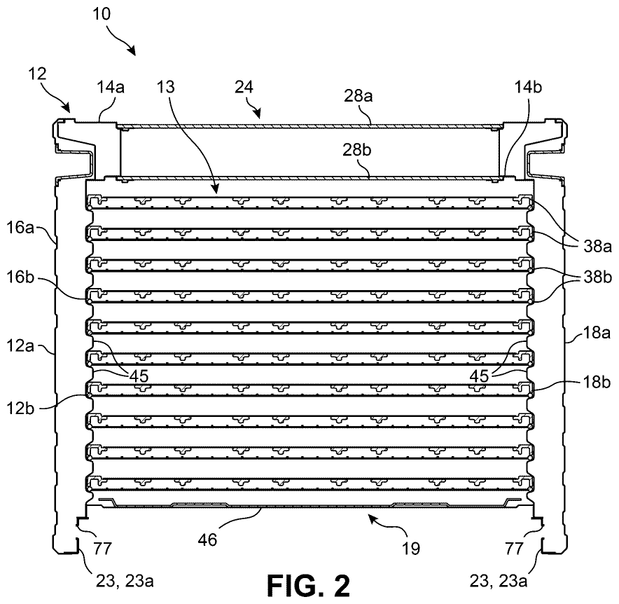

FIG. 2 illustrates each of the laterally opposing pairs of the horizontal projections 45 as having a stack of one of the two-part shelves or trays 38a and one of the integrated shelves or trays 38 resting thereon, such as may be a packaged or shipping configuration of the food dehydrator 10 (and not necessarily an in-use configuration of the different types of shelves or trays 38a, 38b), for showing how a lateral dimension present between each of the opposing horizontal projections 45 at the innermost surfaces thereof is less than that of a lateral dimension of the frame 40a, 40b of either of the disclosed shelves or trays 38a, 38b. This difference in lateral dimension facilitates the ability of each of the shelves or tray 38 to rest in the illustrated horizontal configuration and to slide axially along the corresponding pair of the horizontal projections 45 when installing one of the shelves or trays 38 into the drying chamber 13 via the front opening 36 of the housing 12.

A drip pan 46 for collecting liquid and/or other food item particulates, depicted in FIGS. 2, 3, and 7, may be configured to be removably disposed within the housing 12 at a position vertically delimiting the drying chamber 13 at a bottom thereof such that the portions of the shelves or trays 38 extending across the drying chamber 13 are disposed directly above the drip pan 46 to facilitate the liquid and/or other food item particulates collecting within the drip pan 46 during a corresponding dehydrating process. In the illustrated embodiment, the drip pan 46 is configured to rest on a periphery of the support frame 23a of the support structure 23 defining the vertically extending opening through the housing 12 at the bottom thereof when the drip pan 46 is installed into the food dehydrator 10. In other embodiments where the housing 12 defines a bottom wall below the drying chamber 13, the drip pan 46 may alternatively be configured for reception within a recessed area (not shown) or a through-hole of the corresponding bottom wall for reception on a rim or lip thereof, as desired. It is understood that the drip pan 46 may formed from any suitable material as desired such as a heat-resistant material, for example. It is further understood that the drip pan 46 may have any shape, size, and configuration as desired.

A plenum chamber 50 of the housing 12 is separated from the drying chamber 13 by a partition 52 having a plurality of openings 54 for air circulation (e.g., a perforated or mesh sheet or screen). As best seen in FIG. 3, a blower assembly 56 and/or a heater assembly 64 may be disposed in the plenum chamber 50. In certain embodiments, the blower assembly 56 includes a moveable blower device 58 and an electric motor 60 operably connected to the blower device 58 for causing a rotational movement thereof. The blower device 58 may be mounted in the plenum chamber 50 by a support structure 62. The heater assembly 64 may include one or more heating elements 66 for heating air within the plenum chamber 50. The blower assembly 56 is configured to cause the heated air to flow from the plenum chamber 50 through the openings 54 in the partition 52 to the drying chamber 13. A desired temperature of the air delivered to the drying chamber 13 may be selected by adjustment of a temperature control element of the control panel 30.

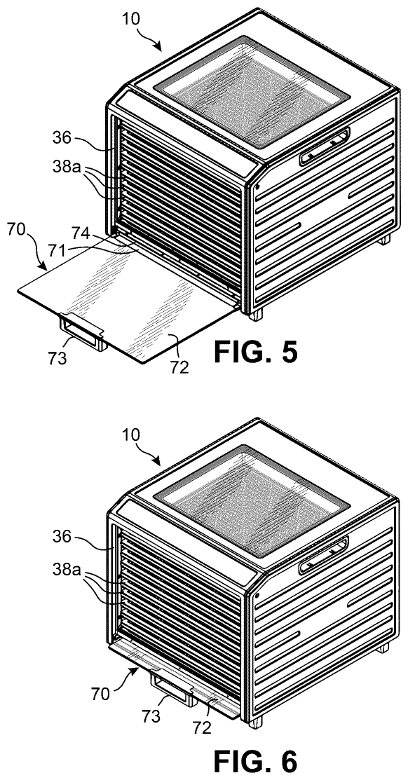

At least one door 70 may be moveably coupled to the housing 12 of the food dehydrator 10 and may be adjustable to a plurality of different positions. The presently disclosed embodiment includes a single door 70 having a stow-away feature, as described in greater detail hereinafter. The door 70 may be selectively positionable between a fully closed position (shown in FIGS. 1 and 3), a fully open position (FIG. 5), and a fully stowed position (FIG. 6). The fully closed position includes the door 70 axially delimiting the drying chamber 13 at the front thereof with the door 70 generally arranged vertically to cover the front opening 36 formed in the housing 12. The fully open position includes the door rotated downwardly about 90° from the vertical arrangement of the door 70 corresponding to the fully closed position to result in the door 70 being generally arranged horizontally at a position in front and below the front opening 36 into the drying chamber 13, wherein each of the shelves or trays 38 disposed on an opposing pair of the horizontal projections 45 is accessible via access to the drying chamber 13 through the front opening 36. The fully stowed position includes a horizontal translation of the door 70 in the rearward axial direction of the food dehydrator 10 to result in the placement of at least a portion of the door 70 within a stowing space 19 disposed under the drying chamber 13 within the housing 12, and more specifically disposed under the drip pan 46 when the drip pan 46 is installed into the food dehydrator 10 in the manner described above. The stowable capability of the door 70 minimizes an amount of counter space needed for the food dehydrator 10 during use, and especially during a loading of the shelves and/or trays 38 into the drying chamber 13 where the user would otherwise have to undesirably reach a distance over the door 70 to reach the horizontal projections 45 when the door 70 is in the fully open and non-stowed position of FIG. 5.

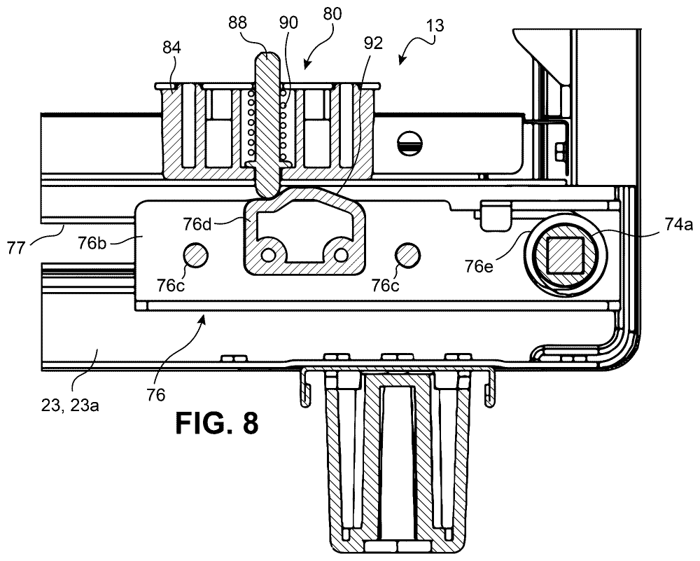

As best shown throughout FIGS. 1, 7, and 8, the door 70 includes a base element 71, a front window 72 formed by a pane of a transparent or semi-transparent material affixed to the base element 71, and a handle structure 73 coupled to the pane of the front window 72 at an end thereof opposite an end of the pane coupled to the base element 71. The base element 71 is coupled to a rotatable shaft 74 in a manner wherein the rotatable shaft 74 and the assembly of the door assembly of the base element 71, the front window 72, and the handle structure 73 all rotate in unison about an axis of rotation of the rotatable shaft 74 when adjusting the door 70 between the fully closed and fully open positions, such as utilizing an axially non-symmetric interface between an outer surface of the rotatable shaft 74 and an opening of the base element 71 receiving the rotatable shaft 74 for establishing the common rotation of the door 70 and the rotatable shaft 74 (shown as a square axially non-symmetric shape in FIG. 8). The rotatable shaft 74 may be disposed to extend longitudinally in the lateral direction to cause the door 70 to rotate about a laterally extending axis of rotation thereof.

The front window 72 provides visual access to the drying chamber 13 within the housing 12 when the door 70 is in the fully closed position covering the front opening 36 of the housing 12. Whereas the upper window 24 provides visual access to the drying chamber 13 from a position directly above the drying chamber 13, the front window 72 provides visual access to the drying chamber 13 from a position directly in front of the drying chamber 13 when the door 70 is in the fully closed position, as the upper window 24 and the front window 72 may be arranged substantially perpendicular to one another when the door is in the fully closed position.

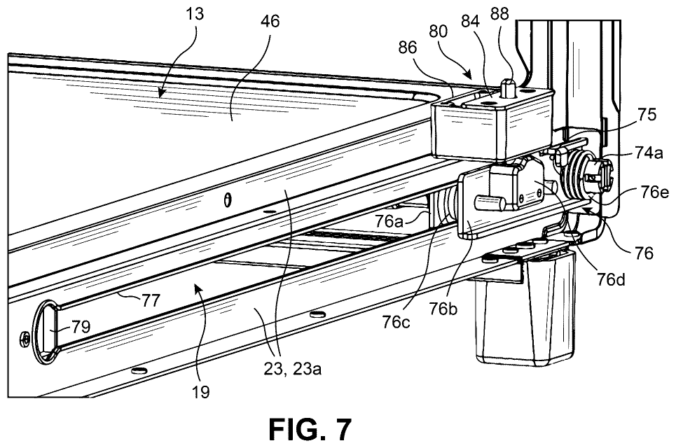

FIG. 7 includes the outer shell 12a and the inner shell 12b removed from the support structure 23 to more easily identify the components facilitating the stow-away capability of the door 70 as described herein, whereas FIG. 8 is a cross-section through such components. The rotatable shaft 74 of the door 70 includes a cylindrical portion 74a at each longitudinal end thereof that is rotatably received through a cylindrical opening 75 of a corresponding slider mechanism 76 disposed to each lateral side of the door 70. Each of the slider mechanisms 76 is configured to slide relative to a rail or track 77 formed in or coupled to a corresponding laterally disposed and axially horizontally extending segment of the support frame 23a to either of the lateral sides of the drying chamber 13. However, in other embodiments, the rail or track may instead be formed in or coupled to one of the lateral walls 16a, 16b, 18a, 18b of the one of the shells 12a, 12b while still straddling the drying chamber 13 in the manner described.

In the presently illustrated embodiment, each of the slider mechanisms 76 includes an inner sliding element 76a disposed to an inner side of the corresponding axially extending segment of the support frame 23a having the rail or track 77, an outer sliding element 76b disposed to an outer side of the corresponding segment of the support frame 23a, a pair of rollers 76c rotatably coupled to each of the sliding elements 76a, 76b and rollably engaging the rail or track 77 for establishing rectilinear translation of the corresponding slider mechanism 76 in the frontward/rearward axial directions relative to the drying chamber 13, an engagement structure 76d coupled to the outer sliding element 76b and protruding therefrom, and a dampening mechanism 76e associated with dampening the rotation of the door 70 when adjusted between the fully open and fully closed positions. A stop block 79 may be disposed at a rearward end of the rail or track 77 for delimiting the axial rearward movement of the door 70 when adjusted from the fully open position to the fully stowed position.

A sliding of the inner and outer sliding elements 76a, 76b relative to the rail or track 77 may only occur when the door 70 is first rotated to the fully open position to arrange the door 70 in alignment with the stowing space 19 formed below the drip pan 46. The slider mechanism 76, the rotatable shaft 74, and the remainder of the door 70 all translate axially rearwardly and forwardly in unison when adjusted between the fully stowed and fully open (non-stowed) positions, which causes the engagement structure 76d to translate towards or away from a corresponding stopper assembly 80 coupled to the housing 12. As best illustrated in FIGS. 7 and 8, each of the stopper assemblies 80 is disposed to one lateral side of the drying chamber 13 and comprises a housing 84 coupled to the support frame 23a and/or one of the side walls 16a, 16b, 18a, 18c by a bracket 86, and each of the stopper assemblies 80 includes a plunger 88 disposed in the housing 84. The plunger 88 is movable between an extended first position and a retracted second position. A biasing element 90 may be employed within the housing 84 to urge the plunger 88 towards the first position. As depicted in FIGS. 7 and 8, the plunger 88 abuts a profile 92 of the engagement structure 76d of the slider mechanism 76 when the slider mechanism 76 slides past the corresponding stopper assembly 80 when moving rearwardly or forwardly, wherein FIGS. 7 and 8 depict the engagement structure 76d engaging the plunger 88 when the slider mechanism 76 is at an axially forward/rearward position corresponding to the door 70 being rotatably adjustable between the fully closed and fully open positions. The illustrated positioning accordingly corresponds to a position of the plunger 88 relative to the profile 92 of the engagement structure 76d when the door 70 is about to be moved from the fully open position in a rearward direction towards the fully stowed position.

The profile 92 of the engagement structure 76d includes opposing tapered or sloped surfaces straddling a vertically projecting portion to allow the engagement structure 76d to provide a stopping feature for preventing undesirable movement of the door 70 between the fully open position and an initial partially stowed position where the door 70 can no longer rotate relative to the housing 12, such as when attempting to close the door 70. The tapered or sloped surfaces press against the plunger 88 and the biasing force of the biasing element 90 to require a slightly greater axial force to be applied to the door 70 by a user to overcome the biasing force and to allow the plunger 88 to move axially (vertically in the case of the plunger 88) in a direction allowing the plunger 88 to pass over the profile 92 of the engagement structure 76d as the slider mechanism 76 is moved axially past the stopper assembly 80.

The dampening mechanism 76e of the slider mechanism 76 may include a torsion spring having opposing ends coupled to the slider mechanism 76 (the outer sliding element 76b in the present embodiment) and the rotatable shaft 74 with the torsion spring configured to dampen the rotation of the door 70 when being repositioned from the fully closed to the fully open positions. That is, a resistive force is applied to the rotatable shaft 74 by the torsion spring along at least an end portion of the downward rotation of the door 70 towards the fully opened and non-stowed position in a manner preventing an undesirable sand sudden dropping or slamming of the door 70.

The food dehydrator 10 as disclosed herein accordingly provides numerous benefits over the food dehydrators of the prior art. First, the inclusion of the upper window 24 above the drying chamber 13 is especially beneficial due to the manner in which such food dehydrators tend to maximize the drying space present therein by stacking multiple layers of shelves or trays vertically above one another, which tends to block the passage of light through the corresponding drying chamber. This may be the case even where internally disposed lights are present within the drying chamber, as the most easily visualized shelves or trays may still not receive enough light due to the remaining shelves or trays (and the food items disposed thereon) obstructing the passage of such light. The upper window 24 accordingly provides a means to view the food items within the drying chamber 13 via the introduction of externally produced light in the absence of any form of visual obstruction. Second, the ability to stow away the door 70 dramatically decreases an area occupied by the food dehydrator 10 during a process of inserting or removing the shelves or trays 38, as the door 70 does not need to remain in a position in front of the drying chamber 13 where a counter space or a standing space of a user may be intruded upon by the door 70. Third, the door 70 includes a dampening means for preventing excessively quick rotational motion of the door 70 when approaching the fully open and non-stowed position as well as a stopping means for preventing undesirably quick axial motion of the door 70 towards the stowed position, each of which aids in properly positioning and maintaining the door 70 in the selected position. Fourth, the inclusion of the recessed area 26 within the upper wall 14a of the housing 12 further aids in reducing an area occupied by the food dehydrator 10 and associated components during the process of handling the food items being dehydrated therein by presenting a work surface directly on the housing 12, as opposed to relying upon a separate area of counter space. The recessed area 26 is also beneficial in maintaining a position of the corresponding shelf or tray 38 during a process of handling food due to the complimentary shapes and configurations thereof wherein the shelf or tray 38 can be partially received within the recessed area 26 and prevented from excessive lateral, axial, or vertical motion during the process of placing food on or removing food from one of the shelves or trays 38. Lastly, the inclusion of an easily identifiable progress indicator 33 on the outer surface of the housing 12 results in the ability for a user to quickly and easily ascertain the dehydration progress regarding the food items disposed within the drying chamber 13 during a dehydration process, which is especially beneficial due to the long periods of time associated with completing such a dehydration process with respect to certain food items (as long as 10 hours or more).

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods may be made within the scope of the present technology, with substantially similar results.

What is claimed is:

1. A food dehydrator comprising:
a housing defining a drying chamber therein, an upper wall of the housing delimiting the drying chamber in a vertical upward direction,
a door moveably coupled to the housing and configured to selectively cover a front opening of the housing providing access to the drying chamber;
an upper window provided in the upper wall of the housing at a position above the drying chamber, the upper window formed of a transparent or semi-transparent material providing visual access to the drying chamber within the housing.

2. The food dehydrator of claim 1, wherein the door includes a front window formed of a transparent or semi-transparent material providing visual access to the drying chamber within the housing when the door is in a fully closed position covering the front opening of the housing.

3. The food dehydrator of claim 2, wherein the upper window provides visual access to the drying chamber from a position directly above the drying chamber and the front window provides visual access to the drying chamber from a position directly in front of the drying chamber when the door is in the fully closed position.

4. The food dehydrator of claim 2, wherein the upper window is arranged perpendicular to the front window when the door is in the fully closed position.

5. The food dehydrator of claim 1, wherein an outer surface of the upper wall of the housing includes a recessed area formed therein, wherein the upper window is disposed within the recessed area of the upper wall.

6. The food dehydrator of claim 1, wherein the upper window includes a first pane of the transparent or semi-transparent material and a vertically spaced apart second pane of the transparent or semi-transparent material.

7. The food dehydrator of claim 1, further including a progress indicator visible on an outer surface of the housing, the progress indicator configured to display a dehydration status of a food item disposed within the drying chamber during a dehydration process of the food dehydrator.

8. A food dehydrator comprising:
a housing defining a drying chamber therein, an upper wall of the housing delimiting the drying chamber in a vertical upward direction,
a door moveably coupled to the housing and configured to selectively cover a front opening of the housing providing access to the drying chamber;
a recessed area formed within an outer surface of the upper wall of the housing, wherein the recessed area is configured to removably receive a shelf or tray therein, wherein the shelf or tray is further configured for removable reception within the drying chamber of the housing and is configured to support a food item thereon.

9. The food dehydrator of claim 8, wherein an upper window is provided in the upper wall of the housing within the recessed area, wherein the upper window is formed of a transparent or semi-transparent material providing visual access to the drying chamber within the housing.

10. The food dehydrator of claim 8, wherein the recessed area has a shape complimentary to a bottom portion of the shelf or tray to restrict movement of the shelf or tray relative to the recessed area.

11. The food dehydrator of claim 8, wherein the shelf or tray is configured to rest on a pair of opposing horizontal projections extending inwardly from opposing lateral side walls of the housing.

12. The food dehydrator of claim 11, wherein the shelf or tray includes a lateral dimension that is less than a lateral dimension of the recessed area and greater than a lateral dimension present between the pair of the opposing horizontal projections.

13. A food dehydrator comprising:
a housing defining a drying chamber therein; and
a door moveably coupled to the housing and configured to selectively cover a front opening of the housing providing access to the drying chamber, wherein the door is selectively positionable between a fully closed position where the door covers the front opening, a fully open position where the door is rotated away from the fully closed position to align the door axially with a stowing space provided within the housing, and a stowed position where the door is disposed at least partially within the stowing space following axial movement of the door towards the stowing space.

14. The food dehydrator of claim 13, wherein the stowing space is provided vertically below a drip pan disposed at a bottom of the drying chamber.

15. The food dehydrator of claim 13, wherein the door is rotatably coupled to a slider mechanism configured to slide axially relative to the housing when the door is being repositioned from the fully open position to the stowed position.

16. The food dehydrator of claim 15, wherein the slider mechanism includes a roller rollably disposed within an axially extending track formed in the housing.

17. The food dehydrator of claim 15, wherein the slider mechanism is configured to cooperate with a stopper assembly to provide a stopping feature for preventing undesired passage of the slider mechanism past the stopper assembly, wherein the stopper assembly has a fixed position relative to a track or rail relative to which the slider mechanism is configured to slide.

18. The food dehydrator of claim 17, wherein the slider mechanism includes an engagement structure and the stopper assembly includes a plunger biased in a direction towards the engagement structure, wherein a profile of the engagement structure includes a tapered surface where the plunger moves against the bias thereof as the profile of the engagement structure passes by the plunger.

19. The food dehydrator of claim 13, wherein a rotatable shaft of the door includes a dampening mechanism configured to dampen rotation of the door when the door is rotated from the fully closed position to the fully open position.

20. The food dehydrator of claim 19, wherein the dampening mechanism is a torsion spring coupled to each of a slider mechanism and the rotatable shaft of the door, wherein the slider mechanism is configured to move in unison with the rotatable shaft of the door during an adjustment of the door from the fully open position to the stowed position.
